(19) United States
(12) Patent Application Publication
(10) Pub. No.: US 2024/0092189 A1
(43) Pub. Date: Mar. 21, 2024

(54) BATTERY ASSEMBLY FOR A VEHICLE

(71) Applicant: ASTON MARTIN LAGONDA LIMITED, Warwick (GB)

(72) Inventors: Ed BOWER, Warwick (GB); Ralph ILLENBERGER, Warwick (GB); Tony KISS, Warwick (GB); Marco ARNOLETTI, Warwick (GB); Remi STOHR, Aachen (DE); Alexander SAUER, Aachen (DE)

(21) Appl. No.: 18/263,651

(22) PCT Filed: Feb. 1, 2022
(86) PCT No.: PCT/EP2022/052311

§ 371 Date: Jul. 31, 2023

(30) Foreign Application Priority Data
Feb. 1, 2021 (GB) 2101388.3

(51) Int. Cl. B60L 50/64; H01M 10/613; H01M 10/625; H01M 10/6568; H01M 50/207; H01M 50/249; H01M 50/30

(52) U.S. Cl. CPC B60L 50/64; H01M 10/613; H01M 10/625; H01M 10/6568; H01M 50/207; H01M 50/249; H01M 50/30; H01M 2200/20

(57) ABSTRACT

The present disclosure relates to a battery assembly for a vehicle such as an electric vehicle or a hybrid electric vehicle, and to methods associated with such an assembly. As disclosed, there is provided a battery assembly for a vehicle, the assembly having a housing, the housing for containing a coolant fluid and at least one battery cell to be cooled by said coolant fluid, the assembly further having a first container volume having a lower portion in fluid communication with an upper portion of the housing, wherein the first container volume has a smaller cross-sectional area in a horizontal plane than that of the housing, and the assembly further having a second container volume having a lower portion in fluid communication with an upper portion of the first container volume. The disclosed battery assembly provides improved battery performance by virtue of improved cell temperature management, particularly when packaging is constrained.

### FIELD

The present disclosure relates to a battery assembly for a vehicle such as an electric vehicle or a hybrid electric vehicle, and to methods associated with such an assembly.

### BACKGROUND

In an electric vehicle (e.g. a fully electric or hybrid electric vehicle, either plug-in or non-plug-in), performance (in terms of acceleration, top speed and range) is to a significant extent determined by the storage capacity, peak/sustained current delivery capacity, and charge/discharge cycle efficiency of the vehicle's battery pack (or “battery assembly”). The battery pack may be constructed from a plurality of individual battery cells, connected in parallel or series, or a combination thereof. The above-mentioned performance factors are in turn dependent to an extent upon the operating temperatures of the cells which make up the battery pack, therefore it is desirable to effectively control the operating temperature of the cells. Constraints on the available space in a vehicle for locating a battery pack can make it challenging to design a battery pack that achieves said requirement to effectively control the operating temperature of the cells. The present disclosure aims to alleviate, at least to an extent, problems associated with existing vehicle battery pack assemblies.

### SUMMARY

According to a first aspect of the present disclosure there is provided a battery assembly for a vehicle, comprising:
a housing, for containing a coolant fluid and at least one battery cell to be cooled by said coolant fluid;
a first container volume having a lower portion, wherein the lower portion of the first container volume is in fluid communication with an upper portion of the housing, wherein the first container volume has a smaller cross-sectional area in a horizontal plane than that of the housing; and
a second container volume having a lower portion, wherein the lower portion of the second container volume is in fluid communication with an upper portion of the first container volume.

Optionally, the housing contains at least one battery cell. Optionally the housing is free from unoccupied internal space into which one or more additional battery cells could fit. Optionally the battery cells are 21700-format cylindrical cells. Optionally the housing comprises an array of battery cells in at least one of a series configuration, a parallel configuration, and a configuration that is a combination of series and parallel. Optionally, the cells are arranged in 12 modules, each module in a 15s4p cell configuration.

Optionally, the housing is provided without internal baffles.

Optionally, the first container volume is provided above the housing or in an upper region of the housing.

Optionally, the second container volume is provided below the first container volume, adjacent the first container volume, and/or at a rear of the housing; and optionally wherein the second container volume has a smaller cross-sectional area in a horizontal plane than that of the housing.

Optionally, at least one of the first container volume and the second container volume has a vertical dimension that is at least equal to any of its horizontal dimensions.

Optionally, at least one of the first container volume and the second container volume comprises at least one internal baffle.

Optionally, the second container volume comprises a breather arranged to allow an upper portion of the second container volume to communicate with atmospheric pressure. Optionally, the breather incorporates one or more of each of the following: a restricted opening; a pressure-regulating valve; and a one-way valve.

Optionally, the second container volume is sealed except for its connection to the first container volume.

Optionally, the housing further comprises a venting channel which extends at least partially across the housing in a region where cells are housed, to facilitate flow of gas and/or fluid from cells to the first container volume.

Optionally, the lower portion of the second container volume is in fluid communication with the upper portion of the first container volume by virtue of a pipe, wherein the pipe is contained within the second container volume. Optionally, the battery assembly further comprises a first burst disc between the first container volume and the second container volume, the burst disc having a burst strength that is selected such that it is exceeded when a pressure transient resulting from a cell thermal event is unable to dissipate through the limited cross-sectional area of the pipe, wherein the first burst disc has a cross-sectional area that is greater than that of the pipe.

Optionally, an upper portion of the second container volume comprises a vent opening that is fluidly connected to a vent pipe, wherein the vent pipe opens to atmosphere at a location below the battery assembly, and the vent pipe has a cross-sectional area that is sufficient to permit venting of gases that may result from a cell thermal event. Optionally, the second container volume further comprises a deflection wall between the first burst disc and the vent opening. Optionally, the vent opening is closed by a second burst disc having a burst strength that is selected so as to resist pressure differentials that result from normal thermal cycling, and to not resist a first pressure differential that would result from a cell thermal event. Optionally, the second burst disc has a burst strength that is selected so as to resist a second pressure differential that would result from a mild cell thermal event.

Optionally, the battery assembly further comprises: one or more pressure or temperature sensors in one or more of the housing, the first container volume, and the second container volume; and a monitoring device that monitors said sensors to determine based upon their outputs whether or not a cell thermal event has occurred, and upon such determination trigger a warning to a vehicle occupant.

Optionally, the housing and the first container volume are completely filled with coolant fluid surrounding at least one battery cell, and the second container volume is part-filled with coolant fluid and part-filled with a gas. Optionally the coolant fluid is a dielectric oil. Optionally the gas is air or nitrogen.

Optionally, the housing and the first container volume have respective openings therein for fluid connection with a pump to enable coolant fluid to be circulated through the housing and around the at least one battery cell. Optionally the opening in the first container volume is at the lower portion of the first container volume. Optionally the opening in the housing is at a lower portion of the housing. Optionally the pump is connected in fluid communication with the housing and the first container volume by one or more pipes. Optionally the battery assembly is arranged such that when in operation with said pump, fluid that has been heated by one or more battery cells is withdrawn from the opening in the first container volume and is returned to the opening in the housing. Optionally the fluid is cooled by passing through a cooler unit, such as a heat exchanger, before being returned to the housing.

Optionally, the arrangement of the battery cells inside the housing combines with the shape of a first wall of the housing to provide a first coolant manifold that is arranged to balance coolant flow around at least a first plurality of cells, thereby minimising temperature differences between said first plurality of cells. Optionally the shape of a second wall of the housing, opposite the first wall, is arranged to provide a second coolant manifold or end tank which receives coolant from the first manifold via at least one cell of the first plurality of cells, and redirects that coolant towards at least one further cell. Optionally the second manifold is taller than the first manifold.

Optionally, the housing has a first horizontal dimension that is transverse when mounted in a vehicle, and which is greater than a second horizontal dimension that is orthogonal to the first horizontal dimension, such that the housing is arranged for transverse mounting in front of the rear wheels and behind the seating area of a vehicle. Optionally the battery assembly further comprises a mounting portion extending forwards from a central portion of the housing, for mounting components associated with the battery assembly including at least one of a coolant pump, a coolant filter, a heat exchanger for cooling coolant fluid, a fuse, a manual switch, a high voltage contactor, a gas venting port, a high voltage connector, and an electrical disconnection point for servicing. Optionally, the mounted components are accessible from underneath the vehicle for ease of servicing.

Optionally, the battery assembly further comprises an attached enclosure for enclosing electronic components that are associated with the battery pack including at least one of a high voltage electronic component, a fuse, a high voltage contactor, a current sensor, a high voltage connector, and an electrical disconnection point for servicing, wherein the enclosure is sealed from the interior of the housing.

According to a second aspect of the present disclosure there is provided a motor vehicle including apparatus as defined according to the first aspect. The motor vehicle may be a volume production motor vehicle registered for use on public roads. Optionally, the battery assembly is mounted behind the seating area and in front of the rear wheels. Optionally, the battery assembly forms a T shape, with the vertical part of the T located in a longitudinal tunnel area of the vehicle, and the horizontal part of the T located behind the seating area.

According to a third aspect of the present disclosure there is provided a method of operating an apparatus as defined according to the first aspect, the method comprising arranging that the housing and the first container volume are substantially completely filled with coolant fluid surrounding at least one battery cell in the housing, and arranging that the second container volume is part-filled with coolant fluid and part-filled with a gas.

According to a fourth aspect of the present disclosure there is provided a method of manufacturing a battery assembly for a vehicle, comprising:
providing a housing, for containing a coolant fluid and at least one battery cell to be cooled by said coolant fluid;
providing a first container volume having a lower portion, wherein the lower portion of the first container volume is in fluid communication with an upper portion of the housing, wherein the first container volume has a smaller cross-sectional area in a horizontal plane than that of the housing; and
providing a second container volume having a lower portion, wherein the lower portion of the second container volume is in fluid communication with an upper portion of the first container volume.

Optionally, the method further comprises fitting at least one battery cell into the housing, optionally such that the housing is free from unoccupied internal space into which one or more additional battery cells could fit.

Optionally, the method further comprises providing the first container volume above the housing.

Optionally, the method further comprises providing the second container volume below the first container volume.

Optionally, the method further comprises providing the second container volume with a breather that allows an upper portion of the second container volume to communicate with atmospheric pressure.

Optionally, the method further comprises substantially completely filling the housing and the first container volume with coolant fluid surrounding at least one battery cell, and part-filling the second container volume with coolant fluid, leaving the second container volume part-filled with a gas.

Optionally, the method further comprises providing the housing and the first container volume with respective openings for fluid connection with a pump to enable coolant fluid to be circulated through the housing and around the at least one battery cell, wherein the opening in the first container volume is at the lower portion of the first container volume, and the opening in the housing is at a lower portion of the housing.

Optionally, the method further comprises mounting the housing to a vehicle, in front of the rear wheels and behind the seating area, wherein a longest horizontal dimension of the housing is aligned transversely.

Optionally, the method further comprises fitting a mounting portion of the battery assembly, that extends forwards from a central portion of the housing, into a longitudinal tunnel area of the vehicle, wherein the mounting portion is for mounting components associated with the battery assembly, said components including one or more of a coolant pump, a coolant filter, a heat exchanger for cooling coolant fluid, a fuse mounting area, and an electrical disconnection point.

Optionally, the method further comprises attaching an enclosure to the battery assembly, wherein said enclosure is for enclosing electronic components that are associated with the battery assembly including at least one of a high voltage electronic component and a high voltage connector, and providing that the enclosure is sealed from the interior of the housing.

According to a fifth aspect of the present disclosure there is provided a method of filling a battery assembly according to the first aspect, the battery assembly further comprising a coolant pump having a filling valve at its inlet, the battery assembly further comprising a degassing valve, the method comprising:
introducing coolant fluid via the filling valve;
allowing air to escape from the housing via the degassing valve;
activating the coolant pump to fill battery cells contained in the housing with the coolant fluid;
continuing to fill the housing, with the coolant pump activated, until coolant fluid flows into the first container volume, and from the first container volume into the lower portion of the second container volume.

It will be appreciated in the light of the present disclosure that certain features of certain aspects and/or embodiments described herein can be advantageously combined with those of other aspects and/or embodiments. The following description of specific embodiments should not therefore be interpreted as indicating that all of the described steps and/or features are essential. Instead, it will be understood that certain steps and/or features are optional by virtue of their function or purpose, even where those steps or features are not explicitly described as being optional. The above aspects are thus not intended to limit the scope of the present invention which is instead defined by the appended claims.

### DESCRIPTION OF FIGURES

Aspects of the disclosure may be carried out in various ways and some preferred embodiments will now be described by way of example only and in a non-limiting way with reference to the accompanying drawings, in which:

FIGS. 1, 2a and 2b show perspective views of a battery assembly for a vehicle according to a described embodiment, including a housing for containing a coolant fluid and at least one battery cell to be cooled by said coolant fluid, and first and second containers;

FIG. 3 is an enlarged view of the second container shown in FIGS. 1 and 2a-2b.

FIG. 4 is a perspective view of a front mounting portion of the battery assembly of an embodiment, for mounting components associated with the battery assembly.

FIGS. 5a and 5b are perspective views showing coolant manifold features built into the housing.

FIG. 6 is a side view of a battery assembly according to an embodiment as shown in FIGS. 1 and 2a-2b, when installed in a vehicle, in front of the vehicle's rear wheels (not shown) and behind a seating area of the vehicle.

FIG. 7 is a perspective view of a battery assembly according to an embodiment as shown in FIGS. 1, 2a, 2b and 6, when installed in a vehicle, in front of the vehicle's rear wheels and behind a seating area of the vehicle.

FIG. 8 is an electrical schematic diagram of a battery assembly according to an embodiment.

FIG. 9 is a flow diagram illustrating a method of providing a battery assembly according to a described embodiment.

FIG. 10 is a perspective view of a battery assembly for a vehicle according to another described embodiment.

FIG. 11 is a cut-away view of the battery assembly shown in FIG. 10.

FIG. 12 is a further cut-away view of the battery assembly shown in FIGS. 10 and 11.

FIG. 13 is a flow diagram illustrating a method of filling a battery assembly according to described embodiments.

### DETAILED DESCRIPTION

Existing high voltage battery packs for electric/hybrid vehicles have been liquid cooled. In such existing battery packs, to allow for expansion/contraction of the liquid coolant and battery pack housing as temperature changes, an air space has typically been provided in the top of the battery pack. The air within previous battery packs also responds to atmospheric pressure, changing its volume in response to pressure changes. That air space mandates a sufficient height of coolant above the battery cells so that they are not uncovered as the air and coolant move under physical forces, e.g. forces resulting from vehicle dynamic movement, or else cells may overheat and cause de-rating of the pack. Thus, the size and weight of the pack is increased.

The presently disclosed high voltage battery pack overcomes these drawbacks in prior battery packs, in summary, by use of first and second containers which are interconnected with the main housing. The housing and first container remain filled with coolant at all times, while the second container contains coolant and an air space, so that coolant can flow to and from the second container to accommodate thermal/atmospheric expansion/contraction. This allows excess coolant volume in the main housing to be removed, thereby saving weight and space, and ensures that all cells in the pack are covered by coolant at all times, even under heavy forces, thereby avoiding battery pack de-rating under heavy and/or sustained electrical loads, which is particularly important in high ambient temperatures.

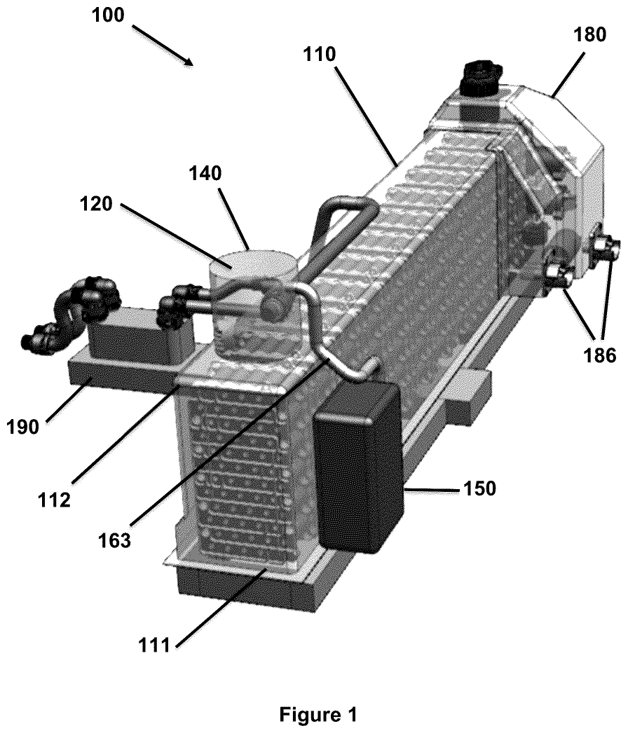

In more detail, as shown in FIG. 1, in an embodiment a battery assembly 100 for a vehicle is provided. Said battery assembly 100 comprises a housing 110 for containing at least one battery cell 130 and a coolant fluid 120 for cooling said at least one battery cell 130. Optionally, the battery assembly 100 comprises the at least one battery cell 130. Further optionally, the at least one battery cell 130 comprises an array of battery cells 130 which are electrically connected in a series arrangement, a parallel arrangement, or a combination of series and parallel arrangements, to achieve a given voltage and current capability, such as in an arrangement having a plurality of modules (e.g. 12 modules), with each module comprising a number of (e.g. 15) series-connected groups of cells, each group comprising a number of (e.g. 4) parallel-connected cells 130. In an embodiment, a BMS (Battery Management System) connects to various points across the array of cells 130 in each module, and observes characteristics such as voltage and temperature for the cells 130. Optionally the battery cells 130 are 21700-format cells, which is a popular cell format providing a degree of future-proofing by way of increasing the likelihood of a future upgrade to improved cells with the same package format.

The housing 110 is arranged to contain a coolant fluid 120, which can be any suitable coolant such as a dielectric oil (e.g. Lubrizol Gen 1, 3M Novec 7000, M&I Mivolt DF7), or if precautions against short circuits are taken in the design of the battery cell interconnections then other coolants such as water can be used. Note: any Trade Marks in the preceding sentence are properties of their respective owners. Said housing can be made of any suitable material that has sufficient mechanical strength, is impermeable, is compatible with the intended coolant, and is suitable for ease of manufacture, for example (but not limited to): any of stainless steel, aluminium, other metals, a plastics material, a composite material, or a combination thereof, depending on required coolant and/or cell carrying capacity, as will be appreciated. Optionally, and in use, the housing 110 is completely filled with the coolant fluid 120, and a desired configuration of battery cells 130, i.e. the volume within the housing 110 is completely filled with battery cells 130 as far as possible or desired, and the remaining spaces between the cells 130 are filled with coolant fluid 120, with no air space remaining in the housing 110. This maximises the number of cells 130 within the housing 110, thereby maximising energy storage capacity, and ensures that all cells 130 are permanently covered in coolant fluid 120, even when the battery assembly is subjected to physical forces such as when a vehicle 400 to which such a battery assembly 100 is fitted is cornering/accelerating/braking hard (for example, if an air space was present then cornering forces would tend to shift the cooling fluid and air in opposite lateral directions, potentially leading to some cells 130 being uncovered). The transfer of coolant fluid 120 and air under physical forces is especially problematic for battery housings that have unequal dimensions, e.g. a transverse dimension 113 that is significantly greater than a longitudinal dimension 114, or vice versa, and when the height of the housing 110 is relatively small compared to either one of those dimensions 113, 114.

A potential problem could result from completely filling the housing 110 with cooling fluid, however. For example, when the housing 110 and/or coolant fluid 120 are subjected to varying temperatures (e.g. −30 to +50 degrees Celsius), thermal expansion causes them to expand or contract (in the case of typical dielectric coolant oils, by approximately 5% over this temperature range), such that the volume of coolant fluid 120 may no longer match the internal volume of the housing 110. Similarly, under heavy mechanical forces (e.g. during vehicle cornering, acceleration or braking), the housing 110 may temporarily distort, leading to changes in its internal volume. An over/underflow mechanism is therefore provided, to allow excess coolant fluid 120 to flow out of the housing 110 if required, or to supply additional coolant fluid 120 into the housing 110 if needed, and thereby prevent excessive positive or negative pressure differential between atmospheric pressure and the pressure inside the housing 110.

Embodiments of the present disclosure provide a solution to the above problem of how to ensure that the housing 110 remains completely filled (or at least more completely filled than has hitherto been possible) with cooling fluid 120 under all driving and environmental conditions, firstly by providing a first container 140 which has upper and lower portions 141,142, wherein the lower portion 141 of the first container 140 is arranged in fluid communication with an upper portion 112 of the housing 110. For example, the first container 140 can be mounted on top of the housing, with corresponding openings in the lower portion 141 of the first container 140 and in the upper portion 112 of the housing 110. In this way, in use when the first container 140 is at least substantially filled with cooling fluid 120, any gas bubbles (such as air) that happen to be in the housing 110 will float to the upper portion 112 of the housing 110, and rise into the first container 140. Since the first container 140 has a relatively large vertical dimension 143 compared with any of its horizontal dimensions 144, a relatively large force in the horizontal direction is required if the interface between the coolant fluid 120 and any air space in the upper portion 142 of the first container 140 is to tilt sufficiently such that the air might flow back into the housing 110. Air thus tends to be captured in the first housing 140, and not flow back into the housing 110 once the air has floated out of the top of the housing 110 into the first container 140. Since the first container 140 has a relatively small cross-sectional area in the horizontal plane (by virtue of its relatively small horizontal dimensions 144) compared to that of the housing 110, the vertical dimension 143 (or height) required of the first container 140, in order to prevent displacement of air from the top (upper portion 142) to the lower portion 141 of the first container 140 under physical forces, is smaller than the height that would be required in a housing 110 that had a similar aspect ratio. Thus, by providing the first container 140, a battery assembly 100 of a given volume can be provided in a relatively wide and flat aspect ratio, while still ensuring that the housing 110 is maintained free of air bubbles (at least to a greater extent than has hitherto been provided for). This greatly assists with packaging of the battery assembly within the vehicle envelope, and other advantages follow such as improved handling by virtue of a lowered centre of gravity.

In an alternative embodiment, the first container 140 can be provided or mounted below or alongside the housing, with the fluid connection between the housing 110 and the first container 140 being provided by a pipe or duct, and with air being encouraged to pass through the pipe or duct from the housing 110 into the first container 140 by a pump 170 or other device to cause flow of fluid from the upper portion 112 of the housing 110 into the lower portion 141 of the first container 140.

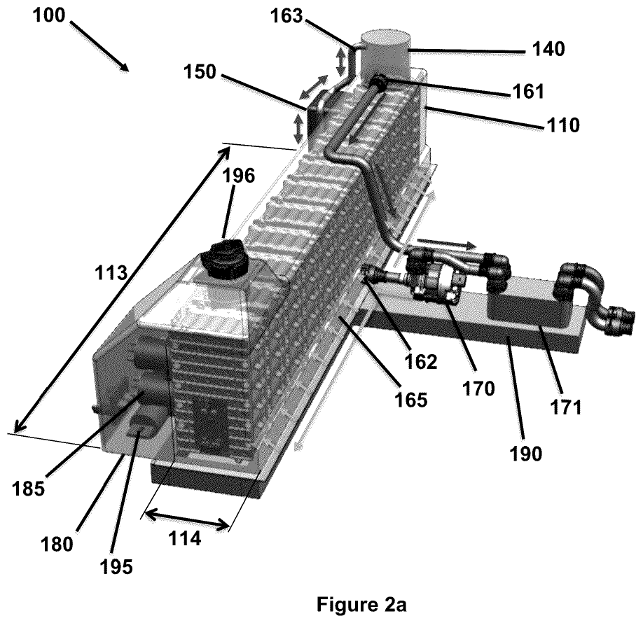

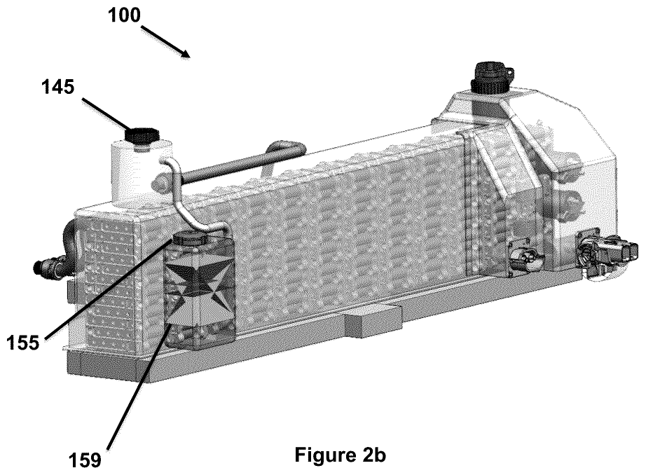

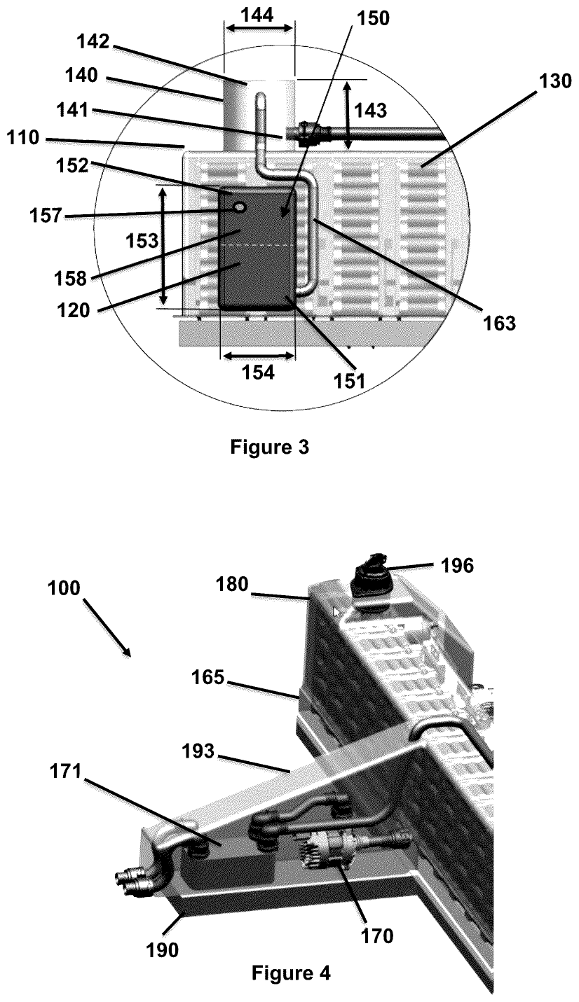

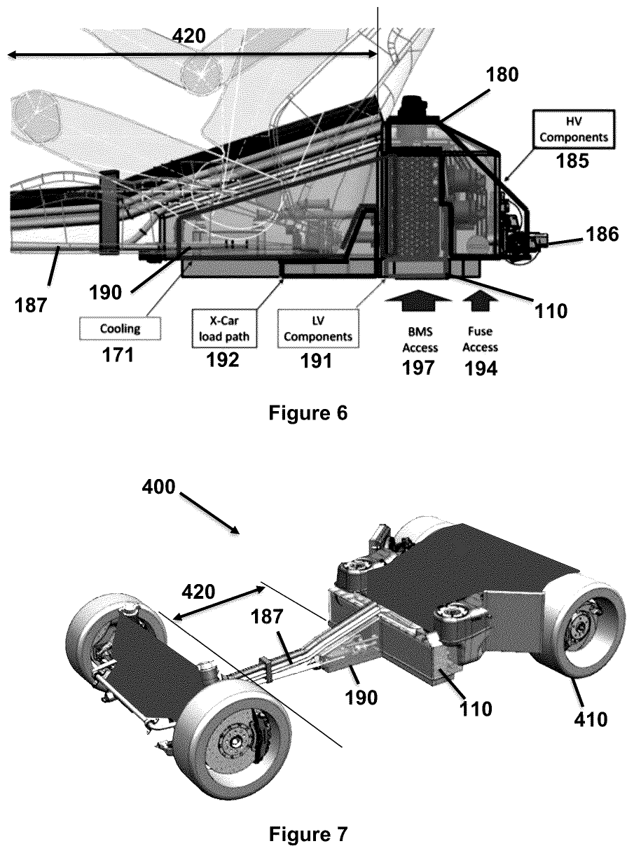

Nevertheless, under extreme lateral or longitudinal forces, in the above embodiments it could still be possible for air to be displaced low enough in the first container 140 for it to be able to flow back into the housing 110 and thereby cause one or more battery cells 130 to be uncovered. By way of a further improvement, therefore, a second container 150 is provided. The second container 150 has a lower portion 151 that is in fluid communication with the upper portion 142 of the first container 140, such that air or excess coolant fluid 120 in the first container 140 can be expelled into the second container 150 under conditions such as when the volume of the housing 110 and/or first container 140 reduces (e.g. due to mechanical forces or thermal contraction) or when the volume of the coolant fluid 120 increases due to thermal expansion. The fluid connection between the lower portion 151 of the second container 150 and the upper portion 142 of the first container can be by a pipe or duct, or by co-location of corresponding openings in the first and second containers 140,150. In the illustrated example embodiment, the second container 150 is mounted or provided on a rear side of the housing 110 (in terms of when the housing 110 is mounted in a vehicle as shown in FIGS. 6 and 7), and the fluid connection is provided by a pipe 163, such that the second container 150 is located below the first container 140. However, in other configurations the second container 150 can be located alongside or above the first container 140. In use, the second container is maintained such that under the aforementioned temperature range and longitudinal and lateral force loadings, the opening of the pipe 163 into the second container 150 remains covered by coolant fluid 120, such that no air can be transferred from the second container 150 to the first container 140. For example, the second container 150 can be sized appropriately for the above condition and maintained approximately half full of coolant fluid 120, such that the lower portion 151 of the second container 150 is filled with coolant fluid 120, and an upper portion 152 of the second container 150 contains a gas such as air or nitrogen. Optionally, the upper portion 152 is provided with a breather 157, in the form of a restricted opening, a pressure-regulating valve and/or one or more one-way valves. FIG. 2b shows possible positions/orientation of the air-coolant interface 159 within the second container 150 under various conditions of coolant expansion and/or lateral/longitudinal forces, showing that the pipe 163 opening to the first container 140 remains covered by coolant fluid 120 under substantially all conditions. Optionally the housing 110 and/or the first container 140 are provided with a filler opening 145 for facilitating said filling. Optionally, the second container 150 is also provided with a filler 155 for facilitating part-filling it with coolant-fluid 120. Optionally, filling the housing 110 and/or first container 140 with coolant fluid 120 is achieved by first evacuating those components and then filling them with coolant fluid 120, and the second container 150 can be part-filled prior to or after that.

In operation, under conditions such as when the volume of the housing 110 and/or first container 140 reduces (e.g. due to distortion of the housing 110 by mechanical forces, or thermal contraction) or when the volume of the coolant fluid 120 increases due to thermal expansion, gas/air or excess fluid in the upper portion 142 of the first container 140 is expelled under the resultant pressure, into the lower portion 151 of the second container 150. Once in the second container, any expelled gas 158 rises to the upper portion 152 of the second container 150, and any expelled coolant fluid 120 remains in the lower portion 151 of the second container 150. Conversely, under conditions such as when the volume of the housing 110 and/or first container 140 increases (e.g. due to distortion of the housing 110 by mechanical forces, or thermal expansion) or when the volume of the coolant fluid 120 decreases due to thermal contraction, coolant fluid 120 from the lower portion 151 of the second container 150 is drawn back into the upper portion 142 of the first container 140 under the resultant vacuum pressure. Any previously expelled air/gas 158 remains in the upper portion 152 of the second container 150, and over subsequent expansion/contraction cycles at least some (and in practice substantially all) gas/air 158 which might initially be present in the housing 110 and/or first container 140 tends to pass into the first container 140 and then into the second container 150. Once air has passed into the second container 150, it is then extremely difficult for it to pass back into the first container 140, even under extreme agitation caused by extreme physical forces such as those which might be experienced during extreme vehicle manoeuvres. That is because unlike the first container 140 that is closely coupled to the housing 110 such that gas can pass from the housing 110 to the first container 140 under gravitation forces or in the reverse direction under forces large enough to counter gravity, passage of gas/fluid between the first the second containers 140,150 generally only occurs during expansion/contraction of the housing 110 and coolant fluid 120. Provided that the construction of the battery assembly 100 is reasonably rigid against changes of volume caused by physical forces, the main motive force for gas/fluid between the first and second containers 140,150 thus becomes thermal expansion/contraction, and therefore passage of gas/fluid between the first and second containers 140,150 generally only occurs during each warm-up or cool-down cycle, and particularly, during cool-down cycles when the flow is from second container 150 to first container 140 the vehicle tends to be stationary such that any gas that is expelled from the first container 140 to the second container 150 tends to remain in the second container 150. Nevertheless, even if some gas remains in the first container 140, or returns to it, the above-described features provide that less gas remains in the first container 140 and housing 110 than in previous battery assembly arrangements. Thus, the above-described arrangement greatly reduces the quantity of coolant fluid 120 that is required to be held in the battery assembly 100, since for example, little or no height of fluid needs to be provided above the array of cells 130 in the housing 110 or first container 140 in order to prevent cells from becoming uncovered during hard cornering, acceleration or braking of a vehicle 400 to which the battery assembly 100 is fitted. This reduction in coolant fluid volume in turn greatly reduces the size and weight of the battery assembly 100.

The gas 158 in the upper portion 152 of the second container 150 provides a spring or cushion that permits coolant fluid 120 to move into and out of the second container 150, and limits pressure excursions in the battery assembly 100 as a whole. The breather 157 in the upper portion 152 of the second container 150, if optionally provided, provides for limiting of a maximum pressure differential between atmospheric pressure and the inside the battery assembly 100. For example, a simple restricted opening breather will, given sufficient time, permit equalisation of pressure between atmospheric pressure and the internal pressure of the battery assembly 100. On the other hand, a pressure-limiting valve can be employed in the breather 157 so as to keep the breather 157 closed unless the pressure differential reaches a threshold. One-way valves can further be combined with a pressure-limiting valve and/or a restricted opening, so as to provide for different over-pressure and under-pressure thresholds. In this way, pressure inside the battery assembly 100 can be regulated so that under different atmospheric conditions, temperatures and altitudes, the pressure differential remains optimal for the construction of the housing 110 and of the first and second containers 140,150. This in turn enables a reduction in the required strength and weight of the battery assembly 100, in particular of the housing 110.

By virtue of the above-described features, the housing 110 is assisted to always remain completely filled with coolant fluid 120, without excessive positive or negative pressure differential between atmospheric pressure and the pressure inside the housing 110. By ensuring that no cells 130 are ever uncovered by coolant fluid 120, even under heavy mechanical forces, the temperature differences between cells 130 are minimised. This in turn reduces the likelihood that any cells 130 will overheat under heavy electrical loads. Given that for series-connected cells 130 (or modules further comprising multiple series or parallel-connected cells 130), the same current flows through each series-connected cell 130 or module, it follows that if any of those series-connected cells 130 or modules experiences an overheated condition then the current through it and through all other series-connected cells 130 or modules must also be reduced until the overheated condition has ended. This effectively means that if any cell 130 overheats then the entire battery assembly power rating must be temporarily reduced (the battery assembly 100 must be “de-rated”), which reduces vehicle performance. Some previous designs have simply accepted that such “de-rating” conditions will occur from time to time, and have designed spare capacity into their battery packs, which has resulted in those battery packs being larger and heavier than would be necessary under ideal conditions. Thus, by preventing cells 130 from being uncovered, overheating conditions are prevented, therefore de-rating is either not required or is reduced, and so the size and weight of a battery assembly 100 can be reduced.

Optionally the first container 140 and/or the second container 150 can be referred to as container volumes, and can be provided either as discrete containers or as container volumes incorporated into the wall of another container, such as by providing extension portions defining volumes that are integrally formed in the housing 110 or in any other fluidly-connected element. By providing the first and/or the second containers 140,150 with respective vertical dimensions 143,153 that are relatively large (e.g. at least equal to) compared with any of their respective horizontal dimensions 144,154, the degree of sideways force required for air to be displaced sideways such that it can reach downwards to the respective lower portion 141,151 of the respective container 140,150, is increased to a level that minimises such occurrence. By way of example, for a coolant fluid 120 volume of approximately 7 litres, the second container 150 can be approximately 1.8 litres, and the first container 140 can be a similar size to the second container 150, with the housing 110 sized appropriately for the desired number of cells 130, which cells 130 are surrounded in use by the coolant fluid 120.

Optionally, such occurrence can be further reduced by including one or more baffles inside one or both of the first and second containers 140,150. Preferably, the housing 110 is free from baffles, so that the maximum amount of its internal space can be occupied by battery cells 130. Preferably, but not essentially, the housing when in use is substantially filled with battery cells 130, meaning that there is no remaining space inside the housing 110 large enough to add further cells 130. Such complete filling of the housing 110 is enabled by the described arrangements which greatly decrease the likelihood that any cells 130 will become uncovered by coolant fluid 120, even when the housing 110 is filled to its top with battery cells 130. This results in increased energy storage capacity for a given battery assembly weight and volume, and permits more flexibility in the design of the shape of the housing 110, thereby permitting a battery assembly with greater storage capacity to be fitted to a given vehicle 400. An example battery assembly weight according to the described embodiments is around 110 kg, including coolant fluid and associated components.

By way of further illustration, a first improved example embodiment can include only the first container 140 at the top of the housing 110, the first container 140 being sized appropriately considering all external forces and expansion so as to substantially reduce or eliminate air pick up into the pump 170. A second, further improved, example embodiment can comprise both first and second containers 140,150, wherein the first container 140 contains some air (and optionally can further include a degas line from the opposite side of the housing 110). In this example embodiment, the first container 140 is sized appropriately to eliminate or at least reduce air pickup by the pump 170, and the second container 150 is provided for coolant fluid 120 expansion, thereby reducing the volume of air required in the first container 140 for expansion purposes, thereby reducing the chance of air being picked up by the pump 170. A third, even more improved, example embodiment comprises the two containers 140,150, wherein the first container 140 is operated without containing air, by virtue of the second container 150 being sized to accommodate both coolant fluid 120 expansion and air, thereby the first container 140 can be smaller. The first and second of these example embodiments may be preferred if a simpler filling strategy is desired, whereas the third of these example embodiments may be preferred for its enhanced performance albeit at the expense of requiring a more complex filling sequence such as vacuum-filling (evacuating before filling).

As shown in FIG. 2a, in the above embodiments a pump 170 is optionally provided for circulating coolant fluid 120 around the battery cells 130, thereby cooling and/or pre-heating the cells 130, and minimising the temperature difference between cells 130, with the above-described benefits. A lower portion 141 of the first container 140 is provided with a first opening 161 for connection to the pump 170. A lower portion 111 of the housing 110 is provided with a second opening 162 for connection to the opposite side of the pump 170. Preferably the inlet side of the pump 170 is connected to the first opening 161 such that in use the pump 170 receives relatively hot coolant fluid 120 that has risen from the upper portion 112 of the housing 110 into the lower portion 141 of the first container 140 under gravitational action, and the outlet side of the pump 170 is connected to the second opening 162 so as to form a coolant circuit such that the received coolant fluid 120 is returned to the lower portion 111 of the housing 110 and is circulated around the battery cells 130. A contrary flow can also be employed, without benefiting from gravitational assistance to the flow. The action of the circulating fluid helps to minimise temperature differences between the cells 130, and thereby avoids de-rating of the battery assembly 100. Optionally, a filter (not illustrated) is included in the coolant circuit for filtering out any debris in the coolant fluid 120. Optionally, a cooler unit (or heat exchanger) 171 is included in the coolant circuit for reducing the temperature of the coolant fluid 120 before it is returned to the lower portion 111 of the housing 110, which further reduces the likelihood of any cells 130 overheating and necessitating de-rating of the battery assembly 100. When a pump 170 is provided, it is not necessary for the first container 140 to be positioned above the housing 100, since a sufficient flow rate can be employed in operation such that any air/gas 158 in the upper portion 112 of the housing 100 is eventually swept by the flow into the lower portion 142 of the first container 140, without relying upon gravitational buoyancy to carry such gas 158.

Also shown in FIG. 2a, the battery assembly further optionally comprises an enclosure 180 that is attached to the housing 100, and which is provided for enclosing electronic components 185 that are associated with the battery assembly 100. By way of example, the electronic components 185 are high voltage components involved in the conversion of power from the battery cells 130. Preferably, the enclosure 180 is sealed from the interior of the housing 110, such that the enclosure 180 can be dry (i.e. not containing coolant fluid 120). Since the components in this enclosure 180 are high voltage components, they operate at lower currents, and therefore resistive heating losses are lower than in the lower voltage components (e.g. the battery cells 130) of the battery assembly 100, therefore liquid cooling is not required. By keeping the high voltage enclosure 180 free of coolant fluid 120, weight is further reduced, as well as environmental impact being reduced, and safety being improved. The high voltage enclosure 180 can be provided with an electrical disconnection point 196 (e.g. a manual service disconnect switch), which when the battery assembly 100 is located in a vehicle 400 can be conveniently placed for operation by service personnel from inside the vehicle or from underneath the vehicle. The high voltage enclosure 180 further comprises at least one high voltage connector 186 for connecting the battery assembly 100 to various components on a vehicle 400 that require power supply/storage provided by the battery assembly 100 (e.g. a Power Distribution Unit can be connected to the battery assembly 100 via a high voltage connector 186, which Power Distribution Unit feeds one or more electric drive units, or alternatively the Power Distribution Unit can be housed inside the high voltage enclosure 180 in which case multiple high voltage connectors 186 can be included on the high voltage enclosure 180).

Optionally, as shown in FIGS. 1, 2, and 4 to 7, the battery assembly 100 can also comprise a mounting portion 190 upon which various components associated with the battery assembly 100 can be mounted, and which can also be used to provide mechanical mounting of the battery assembly 100 to the vehicle 400. Such components can include, but are not limited to, the coolant pump 170, the coolant filter (not shown), the heat exchanger 171 for cooling coolant fluid 120, a fuse 195, a battery management system, a shunt 198, a current sensor 199, a high voltage contactor 188, a gas venting port, a high voltage connector 186, and an electrical disconnection point 196. Thus, the components are easily accessible for servicing. As shown in FIG. 4, a cover 193 can be provided over the mounting portion 190. The mounting portion 190 provides a position for mounting such components which is in a safer location in a crash scenario. For example, said gas venting port (which may be one of one or more high pressure gas venting ports of e.g. 30 mm diameter for emergency venting gas from the housing 110 in the event of a cell failure, as distinct from the breather which can be termed a low pressure venting port) can thus be mounted away from sources of ignition such as hot exhaust pipes or high voltage cables or components, thereby increasing safety in the event of an emergency.

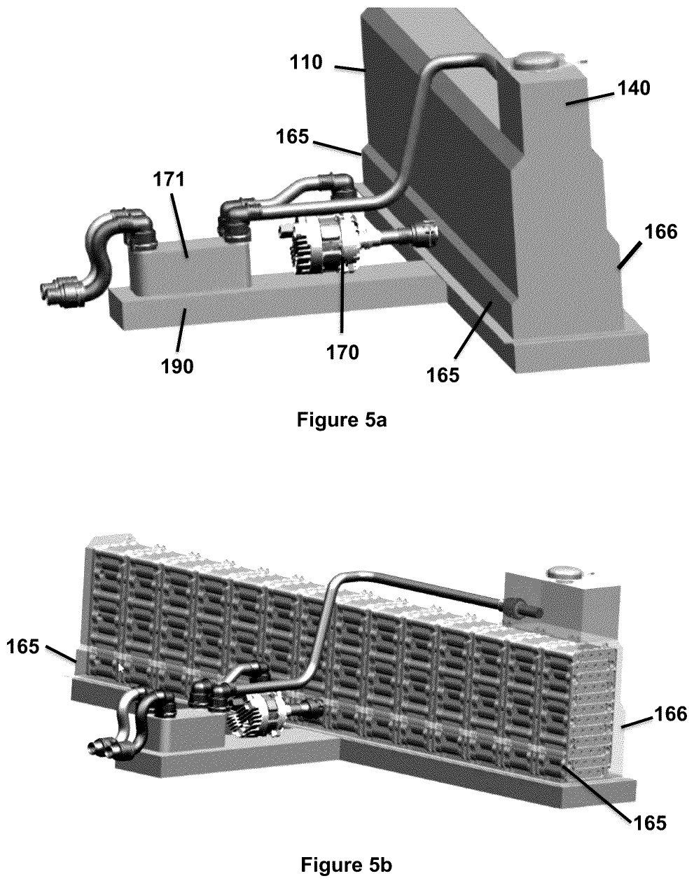

Optionally, the housing 110 can comprise at least one manifold 165 which receives coolant fluid 120 flow from the pump 170 and provides for equal flow through or around each battery module and preferably equal flow around each cell 130. The coolant path through and around each module and/or cell 130 can comprise a single path from the at least one manifold 165, or can optionally comprise multiple passes aided by the optional inclusion of internal baffles, end tanks and/or manifold arrangements. By way of a non-limiting example, as shown in FIGS. 5a and 5b, the housing 110 can optionally comprise a first manifold 165, e.g. in the form of an elongate volume delimited (i) by a widened portion of a longest side of the lower portion 111 of the housing 110 and (ii) by the exterior casings of the battery cells 130. In the example shown in FIG. 5b, 14 battery modules are shown, with each module comprising 12 series-connected groups of 4 parallel-connected cells 130, however as illustrated in FIGS. 1 and 2 (which show 12 modules), a greater number or a smaller number of modules, parallel-connected cells and/or serial-connected cells can be used. The widened portion of the housing (widened in a horizontal direction that is normal to the longest dimension of the housing) provides a space inside the housing 110 for coolant fluid 120 to flow along (from the second opening 162) so that, in use, coolant fluid 120 can reach cells along the entire length of the lower portion 111 of the housing 110 (along the longest dimension of the housing 110). In use, coolant fluid 120 can then flow from the first manifold 165, around cells 130 in the lower portion 111 of the housing and towards the opposite side of the housing 110, and upwards towards the upper portion 112 of the housing 110. By way of a further optional example, as shown in FIGS. 5a and 5b, the housing can optionally further comprise a second manifold or end tank 166, e.g. in the form of a second elongate volume delimited by a second widened portion of the opposite side of the lower portion 111 of the housing 110 and by the exterior casings of the battery cells 130. In use, if included as in this further optional example, the second manifold 166 receives the coolant fluid 120 that has flowed past the battery cells 130 in the lower portion of the housing 110, and since the second manifold 166 is taller than the first manifold 165, the coolant fluid 120 is redirected by the second manifold 166 back towards that longest side of the housing 110 which forms the first manifold 165, at a higher level in the housing 110 such that the coolant fluid 120 passes around cells 130 which are located higher up in the housing 110.

Further in use, having traversed the housing 110 from the longest side upon which the second opening 162 and first manifold 165 are located (optionally to the opposite longest side upon which the second manifold 166 is located, and optionally back again), while rising in the housing 110, the coolant fluid 120 arrives at the upper portion 112 of the housing 110, having passed around and absorbed heat from all of the cells 130. The hot coolant fluid 120 then flows out of the top of the housing 110 and into the lower portion 141 of the first container 140, from where it is drawn off at the first opening 161 by the pump 170, and then optionally filtered and cooled by filter and heat exchanger 171, before being returned to the housing 110 at the second opening 162.

As shown in FIGS. 6 and 7, such a battery assembly 100 can be provided with housing 100 dimensions suitable for installation into a vehicle 400 in a position behind a seating area 420 and in front of the rear wheels 410 of the vehicle 400. This location is assisted by the illustrated relatively low and wide aspect ratio of the housing 110, which is enabled by virtue of the above-described features which assist in ensuring that no battery cell 130 becomes uncovered by coolant fluid 120 even under heavy mechanical forces. Thus, a vehicle 400 can be provided comprising a battery assembly 100 as described herein. As shown in particular in FIG. 6, the mounting portion 190 of the battery assembly 100 conveniently provides a mounting location for components such as a heat exchanger 171 for cooling, low voltage components 191, access to a battery management system 197 and master fuse 195 for ease of servicing, and cooperates with a longitudinal (service or “transmission”) tunnel space in the vehicle 400 floor, to assist with safe routing of high voltage cables 187. Access can also be provided from underneath the vehicle, e.g. on the underside of the housing 110, for removing/replacing cells 130 or cell modules, e.g. via a removable panel. Additionally, the position of the high voltage component enclosure 180 on the housing 110 behind the seating area 420, provides a safe and compact packaging option, which also assists with minimising the length of electrical busbars from the cells to the high voltage components inside the enclosure 180. The location of the electrical disconnection point (manual service disconnect) 196 on top of the high voltage enclosure 180 provides for convenient access by service personnel from inside the vehicle, enabling the vehicle to be made safe before raising it on a lift or jack. Similarly, the position of the second container 150 at the opposite end of the housing 110, behind the seating area 420, provides a safe location for the breather 157 for venting gas 158. Also shown in FIG. 6 is a chassis crossmember (or cross-car load path, labelled “X-Car” load path in the FIG. 192 of the vehicle 400, which crossmember 192 can be arranged in cooperation with the shape of the mounting portion 190 for maximally efficient packaging and maximum strength.

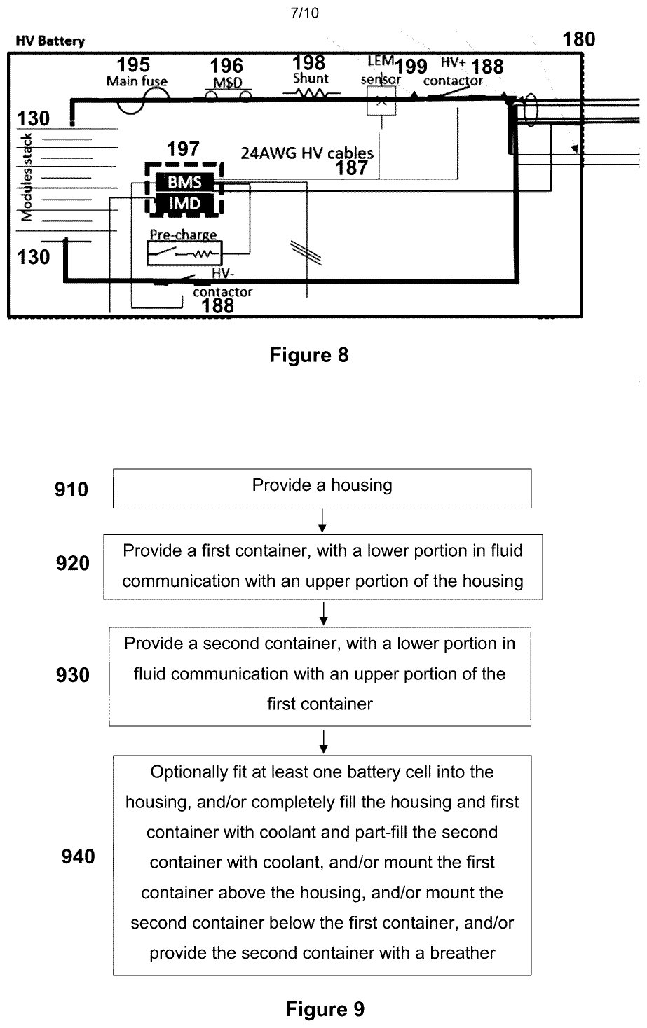

As shown in the electrical schematic diagram of FIG. 8, an array of battery cells 130 are arranged in circuit, with the positive side of the array being connected to a main fuse 195 for protecting against over-current situations, and in turn to an electrical disconnection point (manual service disconnect) 196 for operation by servicing personnel to isolate electrical battery power from the vehicle 400, a shunt resistor 198 (e.g. for sensing current by producing a measurable voltage drop when current flows through it), via a current sensor 199 (e.g. a hall-effect current sensor), and a first high voltage contactor (e.g. a relay) 188 for selectively connecting that series of components to the positive terminal of the high voltage connector 186. From the negative terminal of the high voltage connector 186, a further high voltage contactor (relay) 188 is provided for selectively connecting the negative terminal to the negative side of the array of battery cells 130. A battery management system 197 is connected to, and between, the cells 130, to perform monitoring and failsafe fall-back configuration/operation of the battery cell array, based on monitoring at least one or more parameters including voltage, current and temperature. Thus, if one or more cells 130 are found to have parameters which are out of specification, the battery management system can detect an error, and/or take action such as opening contactors or limiting current flow to prevent damage.

The battery assembly 100 described above can be provided with the housing 100, first container 140 and second container 150 as described, either with or without battery cells 130 and/or coolant fluid 120 inside the housing 100. It will be understood that the battery assembly 100, even if provided without cells 130 and fluid 120, is nevertheless provided with features which permit the interior space of the housing 110 to be more effectively utilised for housing battery cells 130, since those features permit substantially the entire interior space of the housing 110 to be occupied with battery cells 130, having obviated the need for a space above the battery cells 130 to be reserved for only coolant fluid 120 or for internal baffles (as in previous battery assemblies which required such reserved space or baffles to reduce the risk of gas bubbles shifting under mechanical forces to positions where the bubbles might uncover a cell). When the battery assembly 100 is provided without battery cells 130 and/or coolant fluid 120, a method of operating such a battery assembly 100 can be performed, comprising arranging that the housing 110 and the first container 140 are completely filled with coolant fluid 120 surrounding at least one battery cell 130 in the housing 110, and arranging that the second container 150 is part-filled with coolant fluid 120 and part-filled with a gas 158.

As shown in FIG. 9, a method of manufacturing a battery assembly 100 for a vehicle 400, comprises: providing (step 910) a housing 110 for containing a coolant fluid 120 and at least one battery cell 130 to be cooled by said coolant fluid 120; providing (step 920) a first container 140 having a lower portion 141, wherein the lower portion 141 of the first container 140 is in fluid communication with an upper portion 112 of the housing 110, wherein the first container 140 has a smaller cross-sectional area in a horizontal plane than that of the housing 110; and providing (step 930) a second container 150, the second container 150 having a lower portion 151, wherein the lower portion 151 of the second container 150 is in fluid communication with an upper portion 142 of the first container 140. Optionally, the method further comprises (shown as step 940) at least one of: fitting at least one battery cell 130 into the housing 110, such that the housing 110 is free from unoccupied internal space into which one or more additional battery cells 130 could fit; completely filling the housing 110 and the first container 140 with coolant fluid 120 surrounding at least one battery cell 130 in the housing 110, and part-filling the second container 150 with coolant fluid 120, leaving the second container 150 part-filled with a gas 158 (e.g. leaving the upper half of the second container 150 occupied by gas 158); providing or mounting the first container 140 above the housing 110; providing or mounting the second container 150 below the first container 140; and/or providing the second container 150 with a breather 157 that allows an upper portion 152 of the second container 150 to communicate with atmospheric pressure. Optionally, filling the housing 110 and/or first container 140 with coolant fluid 120 is achieved by first evacuating those components and then filling them with coolant fluid 120.

Optionally, the method further comprises providing the housing 110 and the first container 140 with respective openings 162,161 for fluid connection with a pump 170 to enable coolant fluid 120 to be circulated through the housing 110 and around the at least one battery cell 130, wherein the opening 161 in the first container 140 is at the lower portion 141 of the first container 140, and the opening 162 in the housing 110 is at a lower portion 111 of the housing 110. Optionally, the method further comprises mounting the housing 110 to a vehicle 400, in front of the rear wheels 410 of the vehicle and behind a seating area 420 of the vehicle, wherein a longest horizontal dimension 113 of the housing 110 is aligned transversely relative to the vehicle 400. Further optionally, the method comprises fitting a mounting portion 190 of the battery assembly 100, that extends forwards from a central portion of the housing 110, into a longitudinal tunnel area of the vehicle 400, wherein the mounting portion 190 is provided for mounting components associated with the battery assembly 100, said components including one or more of a coolant pump 170, a coolant filter, a heat exchanger 171 for cooling coolant fluid 120, a fuse 195 mounting area, and an electrical disconnection point 196. Further optionally, the method comprises attaching an enclosure 180 to the battery assembly 100, wherein said enclosure 180 is for enclosing electronic components that are associated with the battery assembly 100 including at least one of a high voltage electronic component 185 and a high voltage connector 186, and providing that the enclosure 180 is sealed from the interior of the housing 110.

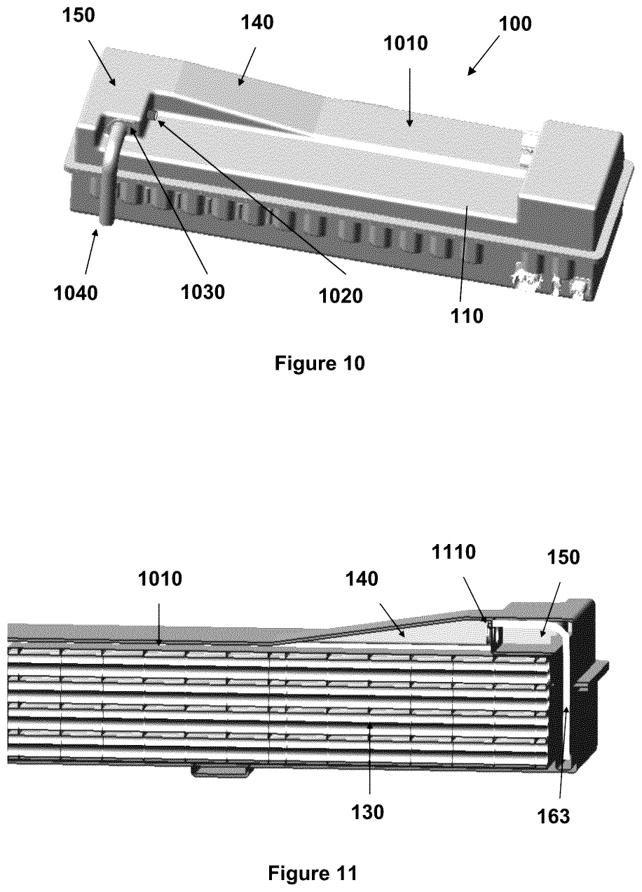

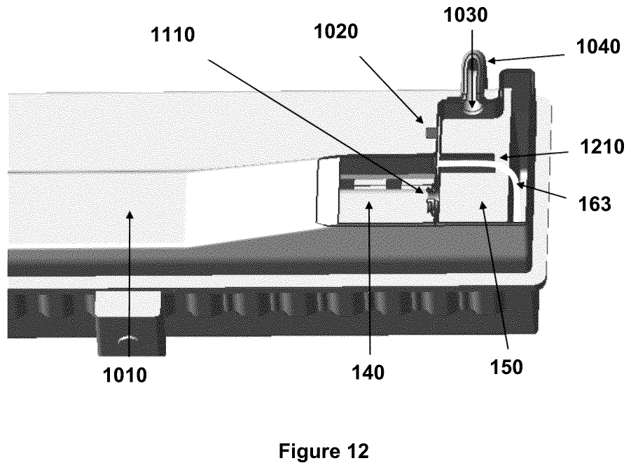

As shown in FIGS. 10 to 12, a further embodiment of a battery assembly 100 is provided, in which the first container 140 and second container 150 are integrated with the housing 110 of the battery assembly 100. In common with previously described embodiments, pipe 163 fluidly connects an upper portion 142 of the first container 140 with a lower portion 151 of the second container 150. In the embodiment shown in FIG. 11 it can be seen that the pipe 163 is contained within second container 150, although in other embodiments said pipe 163 can be partially or fully external to the second container 150. Housing said pipe 163 internally to the second housing 150 is advantageous in terms of compact packaging and reducing the complexity of external features on the battery assembly 100, thereby making it more compact and less susceptible to damage.

Optionally, the battery assembly shown in FIGS. 10 to 12 comprises one or more of the following features which are provided to improve resilience in the event of a battery cell venting event which may cause over-pressure transients. As shown in FIGS. 10 to 12, said battery assembly 100 further includes a venting channel 1010 which extends at least partially across the housing 110 in a region where cells 130 are housed, and provides a channel having sufficient internal cross-sectional area to facilitate gas and/or fluid flow from cells 130 in the housing 110, to the first container 140, thereby reducing localised pressure peaks among the array of cells 130 in the event of a thermal/pressure transient. The interior of the first container 140 is linked (e.g. near its upper portion 142) by a first burst disc 1110 (an opening that is sealed by a membrane made from a material, e.g. metal foil, mylar, an elastomer, that has a strength specifically chosen to breach/burst at a first predetermined differential pressure between its two sides) to the interior of the second container 150 (e.g. near the upper portion 152 of the second container 150). In operation, should an over-pressure event occur in the housing 110, e.g. a high pressure transient originating from a thermal event at a particular cell 130, said pressure transient can travel along the venting channel 1010 to the first housing 140. Because the pipe 163 is required to have a minimum volume so that proper separation of air and fluid can be maintained during pressure cycling, its cross-sectional area is necessarily limited, which limits the ability of the pipe 163 to carry pressure transients between the first container 140 and the second container 150. For this reason, the first burst disc 1110 is provided, which has a greater cross-sectional area than the pipe 163. Upon reaching the first burst disc 1110, the transient will, if of a sufficient magnitude, breach the burst disc 1110 (causing it to rupture). The pressure transient is then dissipated to at least an extent, by virtue of the burst disc 1110 having a larger cross-sectional area (such as 2× to 20×, e.g. 10×) than the pipe 163, thereby allowing the pressure transient to more effectively dissipate into the second container 150 than if the only connection between the first container 140 and the second container 150 was the pipe 163.

Further optionally, the second container 150 comprises a vent pipe 1040, which may connect to the breather 157, or may be substituted for the breather 157. The vent pipe 1040 can be open, in certain embodiments, to permit excess pressure in the second container 150 to be released to atmosphere at a rate that is determined by its cross-sectional area. In the event of a pressure transient within the battery assembly 100 that is large enough to cause a rupture of the first burst disc 1110, it would be undesirable for coolant fluid and/or venting gases to pass through the first burst disc 1110 and then pass directly out of the vent pipe 1040, since that could involve needless loss of coolant fluid and/or violation of environmental controls. A deflection wall 1210 is therefore provided adjacent to the first burst disc 1110 inside the second container 150, to deflect any coolant fluid that may be passing through the first burst disc 1110 at high velocity, so as to at least encourage it to remain in the second container 150 instead of passing directly out of the vent pipe 1040. More specifically, the deflection wall 1210 is arranged so as to necessitate fluid from the first burst disc 1100 to reverse direction if it is to pass out of the vent pipe 1040. For example, the deflection wall 1210 is located between the first burst disc 1110 and the vent pipe 1040, and the deflection wall 1210 extends from a region of the second container 150 where the first burst disc 1110 is located, in a direction away from the first burst disc 1110 towards a wall of the second container 150, and for a distance that is further than a distance between the first burst disc 1110 and the vent pipe 1040. This reversal causes fluid/gas velocity to fall towards zero in a region of the wall of the second container 150, thereby encouraging fluid and aerosols to fall to the bottom of the second container 150 instead of being carried out of the vent pipe 1040 by vent gas flow. In this way, the second container 150 can more effectively contain coolant fluid and prevent it from being lost to the environment. In a further optional embodiment, the vent pipe 1040 is sealed from atmosphere by a second burst disc 1030 having a strength specifically chosen to breach/burst at a second predetermined differential pressure between its two sides, wherein the second predetermined differential pressure is greater than the first predetermined differential pressure. By way of example, the second predetermined differential pressure can be 2× to 10×, e.g. 5×, the first predetermined differential pressure, which advantageously provides that under mild pressure transient conditions the transient can be completely contained within the battery assembly 100 without any leakage of coolant fluid to the environment, while damage to the housing 110 is avoided by virtue of the first burst disc 1110 rupturing to limit the maximum pressure in the housing 110 and first and second containers 140, 150. Thus, effective provision for pressure transients is provided without a need for an open breather hole/pipe or valve. In case of more severe pressure transients, when pressure transferred into the second container 150 via the first burst disc 1110 exceeds the second predetermined differential pressure, the second burst disc 1030 then also ruptures, allowing excess pressure to vent to atmosphere via the vent pipe 1040 and thereby preventing damage to the housing 110 and first and second containers 140, 150. The second burst disc 1030 is preferably located at an upper portion 152 of the second container 150, so that during an overpressure (thermal) event, the thermal event gases and/or the normal air content of the second container 150 (the second container 150 contains approximately 50% air by volume during normal operation) are vented before (in more extreme cases) any venting of coolant fluid occurs. The vent pipe 1040 can be routed such that its outlet is at a lower portion of the battery assembly 100 and at a lower region of the vehicle to which the battery assembly may be fitted, so that coolant liquid and/or gases are discharged safely away from any sources of heat/ignition and away from any openings that could allow gases or liquid to pass into the passenger area.

It is noted that under normal battery assembly 100 operation, when the temperature of the coolant fluid 120 increases, the coolant fluid 120 will expand, and surplus fluid or air in the first container 140 will pass into the second container 150. Due to the pipe 163 opening into the lower region 151 of the second container 150 under the level of coolant fluid 120 in the second container 150, any air will rise to the upper portion 152 of the second container 150. The air in the second container 150 will be compressed by the entry of fluid or air into the second container, leading to a limited increase in pressure (within the ability of the second burst disc 1030 to resist it without rupturing). Conversely, when the temperature of the coolant fluid 120 decreases, the coolant fluid 120 will contract, causing an under-pressure situation in the housing 110 and first container 140 compared with the pressure in the second container 150, which causes coolant fluid 120 to flow back through the pipe 163 from the second container 150 into the first container 140. In this case, since the end of the pipe 163 is positioned under the normal level of coolant fluid 120 in the second container, only coolant fluid 120 is sucked back into the first container 140, rather than any air being returned to the first container 140 (and thus after a number of thermal cycles, any air in the housing 110 or first container 140 is progressively purged into the second container 150). The air in the second container 150 is decompressed slightly as a result of this contraction, and a limited overall reduction in pressure inside the battery assembly 100 results. The strength of the second burst disc 1030 is arranged such that these cyclic pressure increases/reductions in the second container 150 which result from thermal expansion/contraction under normal operation are well within the ability of the second burst disc 1030 to resist without bursting. It is further noted that the pressure rises and falls due to normal expansion/contraction are relatively slow, as opposed to the rapid/transient pressure rise associated with a thermal event in one of the cells 130, and therefore these relatively slow pressure rises/falls are able to pass through the pipe 163 without causing a pressure differential across the first burst disc 1110 that would be large enough to rupture it. On the other hand, the first burst disc 1110 is arranged to be weak enough to burst if pressure in the first container 140 rises faster than the pipe 163 can transfer it to the second container 150, and the second burst disc 1030 is arranged to be weak enough to fail before pressure inside the second container 150 (which will be reflected back into the first container 140 via the first burst disc 1110) rises to dangerous levels that could cause failure of the housing 110, first container 140 and/or second container 150. In an embodiment, the second burst disc 1030 can be arranged to be strong enough to resist moderately large abnormal pressure rises, so as to avoid venting to atmosphere in some cases. Alternatively, the second burst disc 1030 can be arranged to be only marginally strong enough to resist the normal pressure variations in operation due to expansion/contraction, in which case the second burst disc 1030 would be expected to always burst directly following the bursting of the first burst disc 1110 in the event of a thermal event causing a pressure transient. By virtue of the above-described features it can be avoided that thermal runaway of a particular cell 130 causes damage to other cells 130, or at least the amount of damage can be reduced.

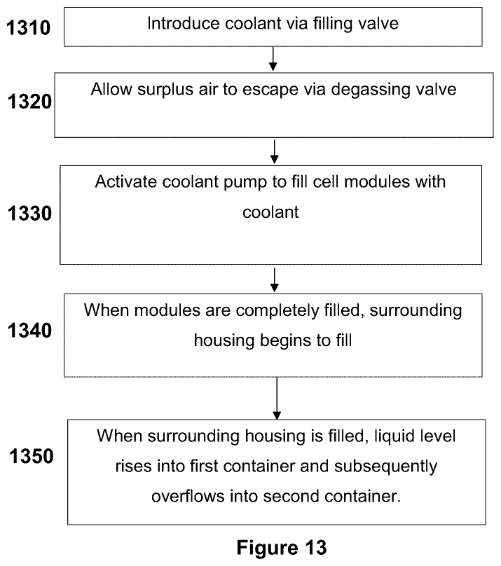

Also shown in FIG. 10 is a degassing valve 1020 which can be used in a procedure for filling the battery assembly 100 as will be described with reference to FIG. 13. Said procedure is designed to completely fill the battery assembly with coolant fluid, leaving only minimal air in the battery module 130 area (in the main housing 110 area where battery modules 130 are housed). In a first operation 1310, coolant fluid 120 is introduced via a filling valve. For example, the filling valve is located just before the coolant pump 170 in a cooling circuit around which the coolant pump 170 circulates the coolant fluid 120 when the pump 170 is operating. In a second operation 1320, surplus air in the housing 110 is allowed to escape via the degassing valve 1020. This is achieved as follows: the surplus air rises in the battery housing 110 and flows into the first container 140, then passes from the upper portion 142 of the first container 140 into the lower portion 151 of the second container 150 via the pipe 163, from where the air rises in the second container 150 and passes out of the second container 150 via the degassing valve 1020 which may be automatically or manually opened for such purpose. In a third operation 1330, the coolant pump 170 is activated (while filling continues), which causes the battery cell modules (module stacks) 130 to fill with coolant liquid 120. At 1340, when the battery cell 130 modules are completely filled with coolant fluid 120, the surrounding housing 110 begins to fill. At 1350, when the surrounding housing 110 is filled with coolant fluid 120, the coolant fluid 120 level rises into the first container 140 and eventually overflows from the upper portion of the first container 140 via the pipe 163 into the lower portion 151 of the second container 150. After these operations the battery housing 110 and first container 140 contain almost no air. The amount of coolant fluid 120 introduced into the filling valve during these operations is chosen (e.g. approximately 1 litre at 20° C. and normal ambient pressure) according to the free interior volume of the battery assembly 100 so that upon completion of the filling procedure the second container 150 is approximately half filled with coolant fluid 120. As previously described, during successive expansion and contraction cycles, any remaining air in the housing 110 passes into the first container 140, and said air is pushed from the first container 140 via the pipe 163 into the second container 150 where it remains by virtue of the open end of the pipe 163 in the second container 150 being below the level of coolant fluid 120 in the second container 150.

By way of a further optional embodiment, one or more temperature and/or pressure sensors can be installed in one or more of: a battery cell 130 or module cavity; the housing 110; the venting channel 1010; the first container 140; and the second container 150. By monitoring said sensors, a cell thermal/venting event can be detected, e.g. by triggering a detection when a temperature and/or pressure threshold is exceeded, and/or when a temperature and/or pressure change in a predetermined time interval is exceeded. Further, the housing 110 can be made of aluminium, and to aid containment of hot gases/flames within the housing 110, the housing 110 can be provided with a heat shield and/or a heat protective coating in vulnerable areas close to cells 130. Such features can help to give a sufficiently timely warning to vehicle occupants that they can leave the vehicle safely.

Various modifications may be made to the preferred embodiments described herein without departing from the scope of the invention as defined by the accompanying claims. Many combinations, modifications, or alterations to the features of the above embodiments will be readily apparent and are intended to form part of the disclosure. Any of the features described specifically relating to one embodiment or example may be used in any other embodiment by making appropriate changes as apparent in the light of the above disclosure.

1. A battery assembly for a vehicle, comprising:
a housing, for containing a coolant fluid and at least one battery cell to be cooled by said coolant fluid;
a first container volume having a lower portion, wherein the lower portion of the first container volume is in fluid communication with an upper portion of the housing, wherein the first container volume has a smaller cross-sectional area in a horizontal plane than that of the housing; and
a second container volume having a lower portion, wherein the lower portion of the second container volume is in fluid communication with an upper portion of the first container volume.

2. The battery assembly of any preceding claim wherein the housing contains at least one battery cell.

3. The battery assembly of claim 2, wherein the housing is free from unoccupied internal space into which one or more additional battery cells could fit.

4. The battery assembly of any preceding claim wherein the housing is provided without internal baffles.

5. The battery assembly of any preceding claim wherein the first container volume is provided above the housing or in an upper region of the housing.

6. The battery assembly of any preceding claim wherein the second container volume is provided in accordance with at least one of the following locations: below the first container volume; adjacent the first container volume; and at a rear of the housing.

7. The battery assembly of any preceding claim wherein at least one of the first container volume and the second container volume has a vertical dimension that is at least equal to to any of its horizontal dimensions.

8. The battery assembly of any preceding claim, wherein at least one of the first container volume and the second container volume comprises at least one internal baffle.

9. The battery assembly of any preceding claim wherein the second container volume comprises a breather arranged to allow an upper portion of the second container volume to communicate with atmospheric pressure.

10. The battery assembly of claim 9, wherein the breather incorporates one or more of each of the following: a restricted opening; a pressure-regulating valve; and a one-way valve.

11. The battery assembly of any preceding claim wherein the second container volume is sealed except for its connection to the first container volume.

12. The battery assembly of any preceding claim, wherein the housing further comprises a venting channel which extends at least partially across the housing in a region where cells are housed, to facilitate flow of gas and/or fluid from cells to the first container volume.

13. The battery assembly of any preceding claim, wherein the lower portion of the second container volume is in fluid communication with the upper portion of the first container volume by virtue of a pipe, wherein the pipe is contained within the second container volume.

14. The battery assembly of claim 13, further comprising a first burst disc between the first container volume and the second container volume, the burst disc having a burst strength that is selected such that it is exceeded when a pressure transient resulting from a cell thermal event is unable to dissipate through the limited cross-sectional area of the pipe, wherein the first burst disc has a cross-sectional area that is greater than that of the pipe.

15. The battery assembly of any preceding claim wherein an upper portion of the second container volume comprises a vent opening that is fluidly connected to a vent pipe, wherein the vent pipe opens to atmosphere at a location below the battery assembly, and the vent pipe has a cross-sectional area that is sufficient to permit venting of gases that may result from a cell thermal event.

16. The battery assembly of claim 15 wherein the second container volume further comprises a deflection wall between the first burst disc and the vent opening.

17. The battery assembly of claim 15 or 16 wherein the vent opening is closed by a second burst disc having a burst strength that is selected so as to resist pressure differentials that result from normal thermal cycling, and to not resist a first pressure differential that would result from a cell thermal event.

18. The battery assembly of claim 17 wherein the second burst disc has a burst strength that is selected so as to resist a second pressure differential that would result from a mild cell thermal event.

19. The battery assembly of any preceding claim further comprising: one or more pressure or temperature sensors in one or more of the housing, the first container volume, and the second container volume; and a monitoring device that monitors said sensors to determine based upon their outputs whether or not a cell thermal event has occurred, and upon such determination trigger a warning to a vehicle occupant.

20. The battery assembly of any preceding claim wherein the housing and the first container volume are completely filled with coolant fluid surrounding at least one battery cell, and the second container volume is part-filled with coolant fluid and part-filled with a gas.

21. The battery assembly of claim 20, wherein the coolant fluid is a dielectric oil, and the gas is at least one of air and nitrogen.

22. The battery assembly of any preceding claim wherein the housing and the first container volume have respective openings therein for fluid connection with a pump to enable coolant fluid to be circulated through the housing and around the at least one battery cell.

23. The battery assembly of claim 22, wherein the opening in the first container volume is at the lower portion of the first container volume.

24. The battery assembly of claim 22 or 23, wherein the opening in the housing is at a lower portion of the housing.

25. The battery assembly of any one of claims 22 to 24, arranged such that when in operation with said pump, fluid that has been heated by one or more battery cells is withdrawn from the opening in the first container volume and is returned to the opening in the housing after having been cooled by passing through a cooler unit before being returned to the housing.

26. The battery assembly of any preceding claim wherein the arrangement of the battery cells inside the housing combines with the shape of a first wall of the housing to provide a first coolant manifold that is arranged to balance coolant flow around at least a first plurality of cells, thereby minimising temperature differences between said first plurality of cells.

27. The battery assembly of claim 26, wherein the shape of a second wall of the housing, opposite the first wall, is arranged to provide a second coolant manifold which receives coolant from the first manifold via at least one cell of the first plurality of cells, and redirects that coolant towards at least one further cell.

28. The battery assembly of any preceding claim wherein the housing has a first horizontal dimension that is transverse when mounted in a vehicle, and which is greater than a second horizontal dimension that is orthogonal to the first horizontal dimension, such that the housing is arranged for transverse mounting in front of the rear wheels and behind the seating area of a vehicle.

29. The battery assembly of claim 28, wherein the battery assembly further comprises a mounting portion extending forwards from a central portion of the housing, for mounting components associated with the battery assembly including at least one of a coolant pump, a coolant filter, a heat exchanger for cooling coolant fluid, a fuse, a manual switch, a high voltage contactor, a gas venting port, a high voltage connector, and an electrical disconnection point.

30. The battery assembly of any preceding claim further comprising an attached enclosure for enclosing electronic components that are associated with the battery pack including at least one of a high voltage electronic component, a fuse, a high voltage contactor, a current sensor, a high voltage connector, and an electrical disconnection point, wherein the enclosure is sealed from the interior of the housing.

31. A motor vehicle including apparatus as defined in any preceding claim.

32. A method of operating an apparatus as defined in any of claims 1 to 30, the method comprising arranging that the housing and the first container volume are substantially completely filled with coolant fluid surrounding at least one battery cell in the housing, and arranging that the second container volume is part-filled with coolant fluid and part-filled with a gas.

33. A method of manufacturing a battery assembly for a vehicle, comprising:
providing a housing, for containing a coolant fluid and at least one battery cell to be cooled by said coolant fluid;
providing a first container volume having a lower portion, wherein the lower portion of the first container volume is in fluid communication with an upper portion of the housing, wherein the first container volume has a smaller cross-sectional area in a horizontal plane than that of the housing; and
providing a second container volume having a lower portion, wherein the lower portion of the second container volume is in fluid communication with an upper portion of the first container volume.

34. The method of claim 33, further comprising fitting at least one battery cell into the housing, such that the housing is free from unoccupied internal space into which one or more additional battery cells could fit.

35. The method of any one of claims 33 to 34, further comprising providing the first container volume above the housing, and providing the second container volume below or adjacent to the first container volume.

36. The method of any one of claims 33 to 35, further comprising providing the second container volume with a breather that allows an upper portion of the second container volume to communicate with atmospheric pressure.

37. The method of any one of claims 33 to 36, further comprising substantially completely filling the housing and the first container volume with coolant fluid surrounding at least one battery cell, and part-filling the second container volume with coolant fluid, leaving the second container volume part-filled with a gas.

38. The method of any one of claims 33 to 37, further comprising providing the housing and the first container volume with respective openings for fluid connection with a pump to enable coolant fluid to be circulated through the housing and around the at least one battery cell, wherein the opening in the first container volume is at the lower portion of the first container volume, and the opening in the housing is at a lower portion of the housing.

39. The method of any one of claims 33 to 38, further comprising mounting the housing to a vehicle, in front of the rear wheels and behind the seating area, wherein a longest horizontal dimension of the housing is aligned transversely.

40. The method of claim 39, further comprising fitting a mounting portion of the battery assembly, that extends forwards from a central portion of the housing, into a longitudinal tunnel area of the vehicle, wherein the mounting portion is for mounting components associated with the battery assembly, said components including one or more of a coolant pump, a coolant filter, a heat exchanger for cooling coolant fluid, a fuse mounting area, and an electrical disconnection point.

41. The method of any one of claims 33 to 40, further comprising attaching an enclosure to the battery assembly, wherein said enclosure is for enclosing electronic components that are associated with the battery assembly including at least one of a high voltage electronic component and a high voltage connector, and providing that the enclosure is sealed from the interior of the housing.

42. A method of filling a battery assembly as defined in any of claims 1 to 30, the battery assembly further comprising a coolant pump having a filling valve at its inlet, the battery assembly further comprising a degassing valve, the method comprising:
introducing coolant fluid via the filling valve;
allowing air to escape from the housing via the degassing valve;
activating the coolant pump to fill battery cells contained in the housing with the coolant fluid;
continuing to fill the housing, with the coolant pump activated, until coolant fluid flows into the first container volume, and from the first container volume into the lower portion of the second container volume.
